(19) United States
(12) Patent Application Publication
(10) Pub. No.: US 2004/0076282 A1
(43) Pub. Date: Apr. 22, 2004

(54) Queue number surveillance

(76) Inventor: Carl Leijonhufvud, Uppsala (SE)

Correspondence Address: SUGHRUE MION, PLLC, 2100 PENNSYLVANIA AVENUE, N.W., SUITE 800, WASHINGTON, DC, 20037, US

(21) Appl. No.: 10/467,084

(22) PCT Filed: Mar. 22, 2002
(86) PCT No.: PCT/SE02/00577

(30) Foreign Application Priority Data
Mar. 27, 2001 (SE) 01010818

(51) Int. Cl. H04M 3/00; H04L 12/56

(52) U.S. Cl. 379/265.02; 370/389

(57) ABSTRACT

The present invention relates to an arrangement and a method, respectively, for surveillance of queue numbers when serving said queue numbers sequentially, comprising: an input device (3; 8), an output device (4) controlled by said input device for outputting a queue number on a queue number ticket, a registration device (5) for receiving a telephone number and a queue number or a point of time associated to a queue number, and a call device (5) for calling said telephone number when said queue number is estimated to be served within a predetermined period of time.

### FIELD OF INVENTION

The present invention generally relates to sequential serving and particularly to a device and a method for sequential serving of queue numbers.

### BACKGROUND

In manual serving in shops, such as post offices and banks, and when checking in at an airport etcetera, or in departments in shops with e.g. cheese and delicacy counters, there are often queue systems allowing customers to be served in order. With a queue number system the customer needs not be limited to queue in line but can sit down or otherwise occupy himself until it is the customer's turn to be served.

It also occurs that shops have a system showing the estimated time until serving for a recently taken queue number. The customer can use this time to occupy himself with other things than queuing physically and without having to survey which number is in turn to be served. E.g. if there is at a delicacy counter five minutes estimated queue time, the customer meanwhile has the time to collect other articles. However, the customer takes a risk by leaving the counter. Firstly, the queue time can be considerably shorter than estimated and secondly the customer can fail to come back in time for serving of his queue number. In both these cases the customer risks that the queue number that he has received has passed when he returns to the counter and he must then take a new queue number.

A customer in a mall has particularly great use of being able to leave a counter or shop where he has received a queue number, as this gives a possibility to visit other shops apart from the one wherein he is queuing.

### SHORT SUMMARY OF THE INVENTION

An object of the present invention is to provide surveillance of queue numbers for a customer, who has received a queue number for sequential serving.

This object, among others, is achieved according to the present invention by an arrangement according to claim 1 and a method according to claim 11, respectively.

An advantage of the present invention is that a customer has the possibility to leave a counter or a shop, where he has received a queue number and to be informed when serving of the queue number is approaching.

Further preferred embodiments are defined by the dependent claims.

Further characteristics and advantages of the present invention will be evident from the following description.

### SHORT DESCRIPTION OF THE DRAWINGS

The present invention will be fully understood by the detailed description of embodiments given below and the enclosed drawings, which are given for illustration only and are thus not limiting for the present invention, wherein:

FIG. 1 schematically shows an arrangement according to a first embodiment of the present invention,

FIG. 2 schematically shows an arrangement according to a second embodiment of the present invention, and

FIG. 3 schematically shows an arrangement according to a third embodiment of the present invention.

### DETAILED DESCRIPTION OF EMBODIMENTS

In the following description specific details are given for explanatory and not limiting purposes, such as particular techniques and applications, in order to provide a thorough understanding of the present invention. However, it will be obvious for a person skilled in the art that the present invention may be performed in other embodiments that differ from these specific details. In other instances detailed descriptions of well-known methods and arrangements are omitted in order not to obscure the description of the present invention with unnecessary details.

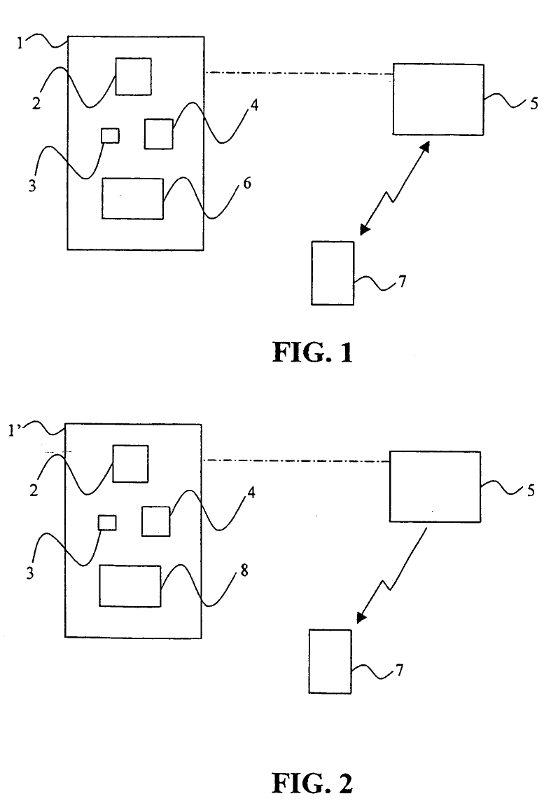

A first embodiment of the present invention will now be described with reference to FIG. 1.

A queue number dispenser 1 comprises a display 2 for displaying an estimated queue time until service and a button 3 for controlling a queue ticket out device 4, such as a printer. One press on the button 3 prints a queue ticket through the printer or outputs a queue ticket through a roll of pre-printed queue numbers.

The queue number dispenser 1 is connected to an electronic control device 5 comprising a processor, such as a microcomputer, positioned either in or at the queue number dispenser 1 or in another place, which is e.g. suitable for computer equipment. The control device 5 registers the number of queuing customers, i.e. the number of printed queue tickets which has not yet been served, and the number of cash desks or serving desks that is in use as well as how fast the customers are being served. From these parameters and e.g. statistics of the customer flow the control device 5 calculates the estimated queue time for a recently taken queue number. This queue time is shown on the display 2 and/or on the queue ticket together with the queue number.

Further, the customer is informed of the fact that surveillance of a queue number may be obtained by calling a specific number, which e.g. is shown on a sign 6 on the queue number dispenser 1.

The customer may by means of e.g. a mobile phone 7 call the control device 5 or send an SMS (Short Message Service) message thereto and there register a queue number and a telephone number, which the control device 5 shall call when the queue number will soon be in turn. Preferably, the telephone number is registered by automatic number identification, such as by a caller identifier, such that the system will not be abused by the customer stating an incorrect telephone number. The queue number is registered e.g. by DTMF (Dual Tone Multi Frequency) signalling.

The call to the registered telephone number, which shall inform that a surveyed queue number is to be served shortly, is carried out a predetermined time, e.g. three minutes, before the estimated time.

Inside a shop it is easy to estimate how long time a customer will need to get to the counter where the serving is to be carried out. In a mall it is more complex to estimate how long it will take a customer to get back to the serving place. Thus, the customer may preferably register a desired buffer time, e.g. five minutes, which states how soon before the queue number is estimated to be in turn, before which the control device 5 shall call that telephone number.

The message to the customer may e.g. be “Welcome to the post office, we estimate to be able to serve you in about five minutes.” either by a spoken message or by a text message, such as an SMS or an e-mail. A text message may also be sent to a pager.

To finance the additional cost for surveillance of queue numbers a fee may be taken out via the specific number called by the customer to obtain surveillance, i.e. via the telephone bill. If a fee is taken out the customer should be informed via the sign 6 that he will be charged for the surveillance and how much the fee is.

Next, a second embodiment of the present invention will be described with reference to FIG. 2.

As in the first embodiment a queue number dispenser 1′ comprises: a display 2 for displaying the estimated queue time, a button 3 for controlling the output, a printer or an out device 4 for outputting a queue number, and a control device 5 for estimating the queue time and for surveillance of queue numbers.

Further, the queue number dispenser 1′ comprises a keypad 8, which can be used to order surveillance of a queue number. Preferably, also a further display (not shown) is arranged for guidance of the customer when he orders surveillance of a queue number, but printed information is also an alternative.

Two methods for ordering surveillance of queue numbers with a queue number dispenser 1′ according to the second embodiment will next be described.

Pressing the button 3 gives an output of a queue ticket stating a queue number. The customer may then via the keypad 8 state a telephone number that he wants to call, a queue number for surveillance and a buffer time before serving. This information (telephone number, queue number and buffer time) is registered by the control device 5, which surveys the queue number and calls the telephone number (e.g. a mobile phone or a pager 7) before the estimated buffer time for serving will be obtained.

Alternatively, the customer specifies via the keypad 8 the telephone number that he wants called and the desired buffer time before serving may be obtained. This information (telephone number and buffer time) and the next queue number are registered by the control device 5, which surveys the queue number as described above. Then, a queue ticket is output with the number to be surveyed (and which was in turn to be output).

The cost for the surveillance may e.g. be taken out by printing a price or code, such as a colour marking, on the queue ticket, and wherein this fee then is charged at the serving place.

Alternatively, a coin slot or cash machine may be used for receiving the fee. The fee may also be used as a deposit that may be returned when paying for the service.

A way of reducing the risk for abuse of the arrangement, i.e. ordering surveillance for the purpose of disturbing the queue system, is to request identification, e.g. by optical readout of the EAN code of an identity card.

A queue number dispenser according to the second embodiment may be combined with a queue number dispenser according to the first embodiment, such that the customer either may call a specific number to the control device or use the keypad of the queue number dispenser to order surveillance of a queue number. The customer may then choose to save a telephone call by using the keypad for ordering surveillance of a queue number.

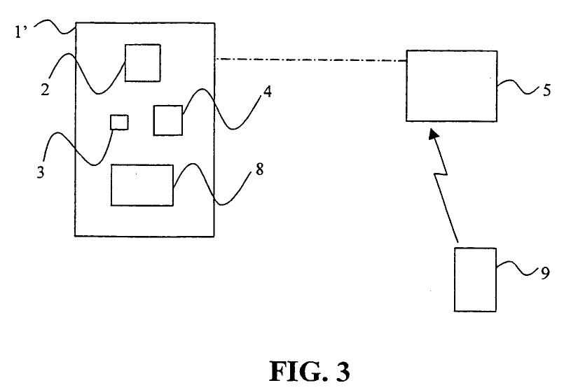

A third embodiment of the present invention will next be described with reference to FIG. 3.

As in the second embodiment a queue number dispenser 1′ comprises: a display 2 displaying estimated queue time, a button 3 for controlling the output, a printer 4 or output device for printing a queue number, a control device. 5 for estimating a queue time and for surveillance of a queue number, and a keypad 8 and preferably a further display (not shown) for interaction with the customer.

The control device 5 is further arranged to receive reservation of a queue number without the customer having to visit the shop, e.g. from a fixed telephone 9 in a home or at an office. It will of course work as well also with a reservation from a mobile phone.

When reserving, the queue number, which is in turn, will be removed from the output order and be reserved in connection with a code, which involve that a customer who immediately after a reservation has been made presses the button 3, receives the queue number that follows the reserved queue number. The one having reserved the queue number will be informed of a code as well as the estimated time until serving. Alternatively the one who reserves a queue number specifies a self-composed code, which shall be used in order to obtain the ordered queue number at the queue number dispenser 1′.

Preferably, the telephone number of the caller is used as the code, automatically obtained via a caller identifier. Partly the caller can easily remember his telephone number; partly the risk is reduced for someone abusing the reservation system by not lo fetching the reserved queue number, as his or her telephone number is known.

At the queue number dispenser 1′ the code for the reserved queue number is then entered via the keypad 8 and the reserved queue number is output.

Suitably, a reserved queue number must be fetched before a certain time before the estimated time for service, e.g. one minute before the estimated time for service. If a reserved queue number ticket is not fetched before the time limit this number will be omitted, i.e. the queue position will be lost. In this way omitted fetching of a queue number ticket will not take up time for other customers. If this method is used the one reserving a queue number should suitably be informed that the reserved queue number will be omitted if it is not collected before the time limit, in this example one minute before the reserved queue number is estimated to be served.

In a corresponding way as according to the first and the second embodiments surveillance of a queue number may be ordered.

Alternatively, it is possible to order surveillance of a queue number associated with a specific time, e.g. 1300. By such a surveillance a queue number is reserved by the control device, when the estimated time to service is of a magnitude corresponding to the remaining time until the surveyed time, i.e. if the estimated queue time at one occasion is e.g. 14 minutes, a queue number is reserved at 1246, when the surveyed time is 1300. In other respects such a reservation works in the same way as a reservation described in the third embodiment.

In case there already exist one or more reservations at a certain desired time. e.g. 1300, the control device may notify the caller that there are other reservations made for that time and give the caller an opportunity to choose another time, e.g. 5 minutes before or 5 minutes after that desired time.

Preferably, in the embodiments described above a confirmation may be requested during a surveillance call, i.e. when the control device calls a registered telephone number shortly before a surveyed queue number is to be served. The customer may then either confirm that he intends to use his queue position or confirm that he cannot and refrains from his queue position. If a fee is taken out from the customer for the surveillance call the customer should be offered a reduced fee if he refrains from his position in the queue in order to encourage the customer to give a correct confirmation. If the customer refrains from his queue position, the corresponding queue number is taken out from the serving sequence.

Further, the customer may be offered reservation of a new queue number, when the customer confirms that he refrains from an earlier queue number. The customer should then be presented the same buffer time as that used for the prior queue number. It should, however, be possible to change the suggested buffer time to a new desired buffer time. If the customer does not wish a new queue number immediately, he can call and order a new surveillance and/or reservation when it suits him.

A fee for providing a reservation service may be taken out, e.g., by debiting the telephone bill or by information on the queue number ticket, as described above, which involves that the service place will charge the fee. An advantage with debiting via the telephone bill is that the surveillance may easily be paid in advance.

Alternatively, the service place may take the costs or even compensate the customer for the telephone call (if a call has been used for ordering surveillance and/or reservation of a queue number) by e.g. reducing the price for purchased articles/services with a predetermined amount.

The third embodiment of the present invention may preferably be combined with the first and/or second embodiment such that when a reservation is being made from a mobile phone it is possible to at the same time order surveillance of the reserved queue number. If surveillance is ordered via a call the customer should be informed of the estimated queue time either as a relative time, such as 30 minutes, or as a definite time, such as 1500.

An advantage with the first embodiment is that queue number dispensers available today do not need to be modified but a separate surveillance unit may be connected thereto.

It has been described above that telephone numbers are identified by means of a caller identifier. It is also possible to use other types of identification, such as transmitting numbers by means of DTMF signalling. Automatic identifications are however preferred in order to reduce the risk for abuse of the surveillance and reservation system, respectively.

If after all the systems are abused the telephone numbers abusing the systems may be blocked from the possibility of ordering surveillance and reservation, respectively, in the future.

Also, it has been described above that the surveillance call to the customer may be a speech message or a text message. Preferably, the customer has a choice where he together with the telephone number, the queue number and the buffer time states that he wishes to be called or that he wishes to receive a text message.

The present invention, especially the third embodiment, may also be used in places that normally have no queue number system, such as parking houses/areas. A reservation and surveillance of a parking place may be ordered via a queue number device, such as described above. The customer is then called when a place has become free and he has then got a certain amount of time to go to the parking house/area, e.g. 15 minutes, before the reservation is removed. Once he arrives to the parking house/area he enters his reservation code in order to be let in into the parking place.

According to the present invention it is in the embodiments described above preferably possible to call a registered telephone number yet another time also after a surveillance call have been made. Such another call may be used to inform the customer that the estimated time until service has been changed, either having been brought forward or postponed. The greatest use of such another call is achieved when the buffer time is long, i.e. when the risk for the time to change is the largest. If the customer is e.g. queuing to a doctor with a buffer time of 30 minutes and he already has received a surveillance call and the doctor thereafter acutely must attend something, such as to perform an operation, the queue time may be increased with several hours. In such a case, the customer will again be called and informed that the estimated service has been postponed, preferably with the information of how long the postponement will be (is estimated to be) as well as that the customer will receive another surveillance call with the same buffer time as the earlier surveillance call. The same applies even if no surveillance call has been made.

Especially when the estimated service has been postponed, but also generally when the queue time is long, it should be possible for the customer to call a telephone number, which may be the same telephone number as when a reservation is ordered, where he can find out the approximate remaining queue time connected to his surveillance code, such as e.g. the telephone number. It should also be possible for the surveillance arrangement to call the queuing person in dependence on the estimated queue time to inform of latest time for collection of a reserved queue number ticket. The first given collection time (given during the reservation call) may e.g. be 10 minutes if the estimated queue time is long or 5 minutes if the estimated queue time is short, which estimation may be based on statistics. When the time for service is closing the estimation of the remaining queue time probably is more exact and the latest time for collection of a reserved queue number ticket may be reduced to e.g. 5 or 3 minutes. This time may be reduced even further, e.g. to 1 minute, either in several steps or in one step, and informed to the customer. A trigger for a call giving a more exact estimated time to service may be when the reserved number is picked from the queue number sequence, as described above.

If a later call informing the user of a more exact time until service is deviating much from the desired reserved point of time the user may want to reject such a queue number as he may not have the possibility to show up at that point of time. Such a rejection is preferably possible and should not be penalized. The largest risk of a much deviating time is when the estimated time until service is long, such as e.g. 30 minutes. It is quite possible that the waiting time actually is less than 20 minutes or over 40 minutes in case the estimated queue time is 30 minutes and 10 minutes difference to a desired reserved time may be to much for the customer.

Also a person other than the one queuing may have use of calling a surveillance arrangement to check if a queue number has been served or not. E.g. someone picking up a person visiting a doctor may want to check if that person has been served in time even when it is not possible to call that person, such as if he is in a place where mobile phones not are allowed. Such another person needs then to know the surveillance code.

The handling of a new surveillance call, i.e. when the service has been postponed, may of course be modified in a way corresponding to an original surveillance call as described above.

It is obvious that the present invention may be varied in a plurality of ways. Such variations shall not be regarded as departures from the scope of the present invention. All such variations obvious to a person skilled in the art are intended to be included within the scope of the present invention.

1. An arrangement for surveillance of queue numbers when serving said queue numbers sequentially, comprising:
an input device (3; 8), and
an output device (4) controlled by said input device for outputting a queue number on a queue number ticket,
characterized by
a registration device (5) for receiving a telephone number and a queue number or a telephone number and a point of time, which point of time is associated with a queue number when an estimated time to service coincide with the time left until said point of time, and
a call device (5) for calling said telephone number when said queue number is estimated to be served within a predetermined period of time.

2. The arrangement according to claim 1, wherein said registration device is arranged to further receive a parameter for establishing said predetermined period of time.

3. The arrangement according to claim 1 or 2, wherein said output device is arranged to indicate on said queue number ticket that said registration device has received a surveillance request, by having received said telephone number and said queue number.

4. The arrangement according to any of claims 1-3, wherein said registration device reserve said queue number and associate that queue number with said telephone number associated with said point of time.

5. The arrangement according to claim 4, wherein said registration device controls said output device, such that said reserved queue number will be printed out in dependence of a reservation code.

6. The arrangement according to claim 4 or 5, wherein said registration device cancels said reserved queue number within a predetermined period of time before estimated service of said reserved queue number.

7. The arrangement according to any of claims 1-6, comprising an indication device (2, 4) for indication of when a queue number is estimated to be served.

8. The arrangement according to any of claims 1-7, comprising means for transmitting telephone numbers and queue numbers to said registration device.

9. The arrangement according to any of claims 1-7, wherein said registration device comprises means for receiving a call from a telephone, such as a mobile phone.

10. The arrangement according to any of claims 1-9, wherein said call device further is arranged to call said telephone number when said estimated time to serve said queue number has changed.

11. A method for surveillance of queue numbers when serving said queue numbers sequentially, characterized by the steps of:
outputting a queue number on a queue number ticket,
registration of said queue number and a telephone number for surveillance of said queue number,
calling said telephone number when said queue number is estimated to be served within a predetermined period of time.

12. The method according to claim 10, wherein said registration step comprises registration of a buffer time for establishing said predetermined period of time.
